(19) United States
(12) Patent Application Publication
(10) Pub. No.: US 2025/0364010 A1
(43) Pub. Date: Nov. 27, 2025

(54) METHOD FOR MANUFACTURING MAGNETIC RECORDING MEDIUM

(71) Applicant: Resonac Hard Disk Corporation, Chiba (JP)

(72) Inventors: Ayumi YAMAKAWA, Chiba (JP); Koshiro YOSHIYAMA, Chiba (JP); Shota SHIMADA, Tokyo (JP); Kazuhiro MAKISHIMA, Tokyo (JP); Kazunori OHASHI, Chiba (JP)

(21) Appl. No.: 19/203,597

(22) Filed: May 9, 2025

(30) Foreign Application Priority Data
May 21, 2024 (JP) 2024-082727

(51) Int. Cl. G11B 5/84; G11B 5/82

(52) U.S. Cl. CPC G11B 5/8404; G11B 5/82

(57) ABSTRACT

A method for manufacturing a magnetic recording medium includes burnishing a surface of a laminated structure using an abrasive material, the laminated structure including a magnetic recording layer and a protective layer successively laminated on a substrate. The burnishing includes using a long abrasive tape including abrasive grains as the abrasive material fixed on a support in a state wound in a roll shape, and pressing the abrasive tape supplied from the state wound in the roll shape against the surface of the laminated structure, thereby abrading the surface of the laminated structure. The abrasive tape in the state wound in the roll shape is re-rolled in advance to remove loose abrasive grains therefrom.

### CROSS-REFERENCE TO RELATED APPLICATIONS

This application is based upon and claims priority to Japanese Patent Application No. 2024-082727, filed on May 21, 2024, the entire contents of which are incorporated herein by reference.

### FIELD

Certain aspects of the embodiments discussed herein are related to methods for manufacturing magnetic recording media.

### BACKGROUND

In recent years, magnetic storage devices are provided in various products, such as personal computers, video recorders, data servers, or the like, and the importance of the magnetic storage devices is increasing. The magnetic storage device includes a magnetic recording medium that stores electronic data recorded by magnetic recording, and may be a hard disk drive (HDD), for example.

A general magnetic recording medium has a multilayer film including an underlayer, an intermediate layer, a magnetic recording layer, and a protective layer that are successively formed in this order on a non-magnetic substrate, for example. A lubricant layer may be formed on a surface of the protective layer.

When manufacturing the magnetic recording medium, a burnishing process using an abrasive tape is performed in order to remove foreign substances and protrusions on the surface of the protective layer (refer to Japanese Examined Patent Application Publication No. H2-10486, for example).

The burnishing process uses an abrasive tape 100 illustrated in FIG. 1 having abrasive grains 102 of alumina or the like fixed on a resin film 101 using a resin. The abrasive tape 100 has a width of several cm and a length of approximately 100 m. This long abrasive tape 100 is supplied in a state wound around a core material 110 in a roll shape.

When foreign substances or loose abrasive grains mix into the abrasive tape 100, circumferential scratches are generated on the surface of the multilayer film during the burnishing process, and dirt easily adheres to the scratched surface of the multilayer film. For this reason, the abrasive tape 100 is manufactured under quality control, so that the foreign substances or loose abrasive grains do not mix into the abrasive tape 100 during the manufacturing process. However, when manufacturing the magnetic recording medium, there is a problem in that scratches or dirt, which may be regarded as being caused by the burnishing process, are still generated in some cases. Magnetic recording media having the scratches, dirt, or the like on the surface of the multilayer film are treated as defective products, thereby deteriorating a productivity of the magnetic recording media.

### SUMMARY

Accordingly, it is an object in one aspect of the embodiments to provide a method for manufacturing a magnetic recording medium, capable of improving the productivity of the magnetic recording media.

According to one aspect of the embodiments, a method for manufacturing a magnetic recording medium, includes burnishing a surface of a laminated structure using an abrasive material, the laminated structure including a magnetic recording layer and a protective layer successively laminated on a substrate, wherein the burnishing includes using a long abrasive tape including abrasive grains as the abrasive material fixed on a support in a state wound in a roll shape, and pressing the abrasive tape supplied from the state wound in the roll shape against the surface of the laminated structure, thereby abrading the surface of the laminated structure, and the abrasive tape in the state wound in the roll shape is re-rolled in advance to remove loose abrasive grains therefrom.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a schematic diagram illustrating an example of an abrasive tape wound into a roll shape;

FIG. 2 is a cross sectional view illustrating an example of a magnetic recording medium manufactured by a method for manufacturing the magnetic recording medium according to one embodiment of the present invention;

FIG. 3 is a diagram for explaining a burnishing process;

FIG. 4 is a cross sectional view on an enlarged scale illustrating an example of the abrasive tape including an abrasive material used during the burnishing process;

FIG. 5 is a schematic diagram illustrating an example of a method for removing loose abrasive grains;

FIG. 6 is a schematic diagram illustrating the example of the method for removing the loose abrasive grains; and

FIG. 7 is a diagram illustrating an example of a burnishing apparatus used during the burnishing process that burnishes a surface of the laminated structure with the abrasive tape.

### DESCRIPTION OF EMBODIMENTS

Preferred embodiments of the present invention will be described with reference to the accompanying drawings. In order to facilitate understanding of the disclosure, the same parts or constituent elements in the drawings are designated by the same reference numerals, and a redundant description thereof may be omitted, as appropriate. In addition, the scale of each part or constituent element in the drawings may be different from the actual scale. In the present specification, a numerical range of “A to B” refers to a range including a lower limit value A and an upper limit value B, unless indicated otherwise.

The present inventors focused on the fact that the rate of occurrence of defective products due to circumferential scratches and dirt on the surface of a magnetic recording medium is correlated to a position of an abrasive tape in a roll of the abrasive tape used in a burnishing process, and found that the rate of occurrence of defective products due to the burnishing process is higher at positions outside the roll of the abrasive tape than at positions inside the roll of the abrasive tape, that is, at a core side of the abrasive tape. As a result of investigations conducted by the present inventors on the cause therefor, it was found that loose abrasive grains are generated by a pressure from a winding tension of the abrasive tape when wound into the roll shape, and that the loose abrasive grains cause the defective products. Because the pressure from the winding tension is different between the positions inside and the positions outside the roll of the abrasive tape, the amount of the loose abrasive grains is different between the inside and the outside of the roll of the abrasive tape. Accordingly, the present inventors found that a productivity of magnetic recording media can be improved by re-rolling the abrasive tape in a state wound into the roll shape before use to remove the loose abrasive grains.

The present invention has the following configurations.

[1] A method for manufacturing a magnetic recording medium, comprising:

burnishing a surface of a laminated structure using an abrasive material, the laminated structure including a magnetic recording layer and a protective layer successively laminated on a substrate, wherein:

the burnishing includes using a long abrasive tape including abrasive grains as the abrasive material fixed on a support in a state wound in a roll shape, and

pressing the abrasive tape supplied from the state wound in the roll shape against the surface of the laminated structure, thereby abrading the surface of the laminated structure, and
the abrasive tape in the state wound in the roll shape is re-rolled in advance to remove loose abrasive grains therefrom.

[2] The method for manufacturing the magnetic recording medium according to [1] above, wherein the loose abrasive grains are abrasive grains released from the support of the abrasive tape.

[3] The method for manufacturing the magnetic recording medium according to [1] or [2] above, wherein the loose abrasive grains are removed by blowing off the loose abrasive grains using a gas.

[4] The method for manufacturing the magnetic recording medium according to [1] or [2] above, wherein the loose abrasive grains are removed by bringing another tape into contact with the surface of the abrasive tape to adsorb the loose abrasive grains onto the other tape.

[5] The method of manufacturing the magnetic recording medium according to any one of [1] to [4] above, further comprising:

forming a lubricant layer on the surface of the laminated structure,
wherein the burnishing burnishes the surface of the laminated structure formed with the lubricant layer using the abrasive material.

Before describing a method for manufacturing a magnetic recording medium according to one embodiment of the present disclosure, a magnetic recording medium manufactured by the method for manufacturing the magnetic recording medium according to the present embodiment will be described.

### Magnetic Recording Medium

FIG. 2 is a cross sectional view illustrating an example of a magnetic recording medium manufactured by the method for manufacturing the magnetic recording medium according to the present embodiment. As illustrated in FIG. 2, a magnetic recording medium 1 includes a laminated structure 11, and lubricant layers 12 provided on opposite surfaces (that is, upper and lower surfaces) of the laminated structure 11.

The laminated structure 11 includes a substrate 111, a magnetic recording layer 112, and a protective layer 113 successively laminated in this order on an upper surface of the substrate 111, and a magnetic recording layer 112 and a protective layer 113 successively laminated in this order on a lower surface of the substrate 111.

The substrate 111 is formed of a nonmagnetic material. The substrate 111 may be a metal substrate formed of a metal material, such as an aluminum alloy or the like. Alternatively, the substrate 111 may be a non-metal substrate formed of a non-metal material, such as glass or the like. Further, a NiP alloy layer may be formed on the surface of the metal substrate or the nonmetal substrate, using a plating method, a sputtering method, or the like, for example.

The magnetic recording layer 112 is provided for recording information thereto and reproducing information therefrom. For example, the magnetic recording layer 112 can store data by reversing a direction of magnetization by a magnetic energy supplied from a magnetic head of a HDD, and maintaining the state of magnetization.

The magnetic recording layer 112 may be formed of FePt-based alloys having a L1₀ structure, CoPt-based alloys having a L1₀ structure, CoCrPt-based alloys having an hcp structure, or the like.

The magnetic recording layer 112 can be formed by a known method, such as sputtering, ion beam deposition, or the like.

The protective layer 113 is provided to prevent corrosion of the magnetic recording layer 112, to protect the surface of the magnetic recording medium 1 by preventing damage to the surface when the magnetic head makes contact with the magnetic recording medium 1, and to increase a corrosion resistance of the magnetic recording medium 1.

The protective layer 113 can be formed of a known material, such as a hard carbon film, a diamond-like carbon (DLC), or the like, for example.

The protective layer 113 can be formed by a known method, such as sputtering, ion beam deposition, or the like.

The surface of the protective layer 113 may be hydrogenated or nitrogenated. By hydrogenating or nitrogenating the protective layer 113, the protective layer 113 can enhance a bonding strength with respect to the lubricant layer 12 formed on the surface of the protective layer 113.

The lubricant layer 12 is provided to reduce frictional wear of the surfaces of the magnetic head and the magnetic recording medium 1 when the magnetic head makes contact with the magnetic recording medium 1, and to increase the corrosion resistance of the magnetic recording medium 1.

The lubricant layer 12 is formed using a lubricant. A lubricant, that is generally used when manufacturing magnetic recording media, may be used for the lubricant layer 12.

A thickness of the lubricant layer 12 is preferably in a range of 5 Å to 10 Å (0.5 nm to 1 nm). By setting the thickness of the lubricant layer 12 to the range of 5 Å to 10 Å, it is possible to reduce the frictional wear of the surface of the magnetic recording medium 1, to increase the corrosion resistance of the magnetic recording medium 1, and to achieve a high recording density by reducing a distance between the magnetic head and the magnetic recording medium 1 in the HDD.

### Method for Manufacturing Magnetic Recording Medium

A method for manufacturing the magnetic recording medium according to the present embodiment includes a laminated structure forming process (or step), a coating process (or step), and a burnishing process (or step). The laminated structure forming process forms the laminated structure 11 in which the magnetic recording layer 112 and the protective layer 113 are laminated in this order on both principal surfaces of the substrate 111. The coating process coats the lubricant on the surface of the laminated structure 11. The burnishing process burnishes the surface of the laminated structure 11 coated with the lubricant, using an abrasive material.

In the method for manufacturing the magnetic recording medium according to the present embodiment, the burnishing process may be performed before the coating process, and the surface of the laminated structure 11 in a state not coated with the lubricant may be burnished using the abrasive material.

Moreover, in the method for manufacturing the magnetic recording medium according to the present embodiment, the laminated structure forming process may include other processes (or steps), such as a process (or step) of forming an adhesion layer, a soft magnetic underlayer, a seed layer, an orientation control layer, or the like between the substrate 111 and the magnetic recording layer 112, or the like.

Further, in the method for manufacturing the magnetic recording medium according to the present embodiment, in a case where the laminated structure 11 includes a plurality of laminated magnetic recording layers 112, the laminated structure forming process may include a process (or step) of forming a non-magnetic recording layer between the adjacent magnetic recording layers 112.

In the method for manufacturing the magnetic recording medium according to the present embodiment, the laminated structure forming process first forms the laminated structure 11 in which the magnetic recording layer 112 and the protective layer 113 are laminated in this order on both principal surfaces of the prepared substrate 111.

The laminated structure 11 can be formed, using a general deposition method for forming the magnetic recording layer 112 and the protective layer 113.

First, the magnetic recording layers 112 are formed on both principal surfaces of the substrate 111. The magnetic recording layers 112 may be formed by a general deposition method, such as a sputtering method or the like. The method for forming the magnetic recording layers 112 is not particularly limited.

When using the sputtering method, it is possible to use a target including a material for forming the magnetic recording layers 112.

For example, FePt-based alloys having a L1₀ structure, CoPt-based alloys having a L1₀ structure, CoCrPt-based alloys having a hcp structure, or the like can be used for the target including the material for forming the magnetic recording layers 112.

A DC sputtering method, a direct current (DC) magnetron sputtering method, a radio frequency (RF) sputtering method, or the like can be used as the sputtering method.

When forming the magnetic recording layers 112, an RF bias, a DC bias, a pulse DC bias, or the like may be used, as required.

O₂ gas, H₂O gas, N₂ gas, or the like may be used as a reactive gas.

A sputtering gas pressure is appropriately adjusted so that properties or characteristics of each layer are optimized. Usually, the sputtering gas pressure is in a range of approximately 0.1 Pa to approximately 30 Pa.

Next, the protective layers 113 are formed on the magnetic recording layers 112, respectively. The method of forming the protective layers 113 is not particularly limited, and a general deposition method, such as a radio frequency-chemical vapor deposition (RF-CVD) method for decomposing a source gas formed of hydrocarbon by high-frequency plasma to form the film, an ion beam deposition (IBD) method for ionizing a source gas by electrons emitted from a filament to form the film, a filtered cathodic vacuum arc (FCVA) method for forming the film using a solid carbon target without using a source gas, or the like, for example, can be used for forming the protective layers 113.

In the laminated structure forming process of the present embodiment, an adhesion layer, a soft magnetic underlayer, a seed layer, an orientation control layer, or the like may be formed between the substrate 111 and the magnetic recording layer 112.

In the present embodiment, in the case where the laminated structure 11 includes a plurality of laminated magnetic recording layers 112, the laminated structure forming process may include a process (or step) of forming a non-magnetic recording layer between the adjacent magnetic recording layers 112.

Next, the coating process coats a lubricant on opposite surfaces of the laminated structure 11 to form the lubricant layers 12 which are films formed of the lubricant. Thus, the laminated structure 11 having the lubricant layers 12 formed on the opposite surfaces thereof is obtained.

The lubricant can be coated by a general coating method, such as a dip coating method, a spin coating method, a vapor deposition method, or the like.

As described above, the burnishing process can be performed before or after the coating process. Hence, in the following description, the burnishing process will be described as being performed with respect to a laminated structure 11A, which may correspond to the laminated structure 11 without the lubricant layers 12, or correspond to a laminated structure (substantially corresponding to the magnetic recording medium 1) having the lubricant layers 12.

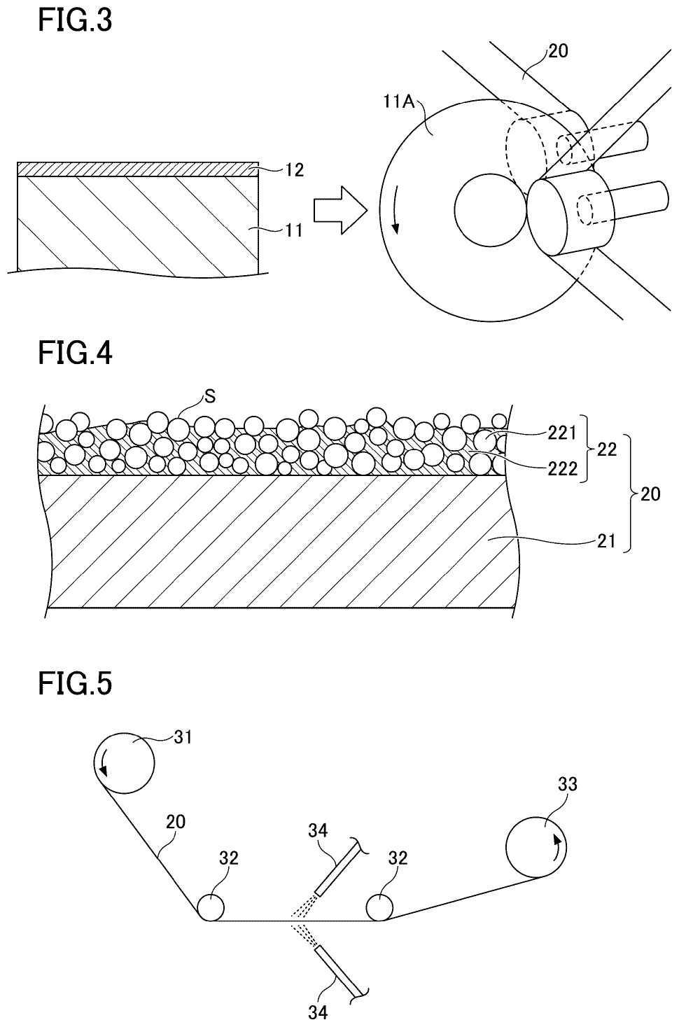

Next, as illustrated in FIG. 3, the burnishing process burnishes opposite surfaces of the laminated structure 11A, using abrasive tapes 20.

The burnishing is performed using the abrasive tapes 20 wound in a roll shape, and the abrasive tapes 20 supplied from the state wound in the roll shape is pressed against the surfaces of the laminated structure 11A, thereby abrading the surfaces.

In the present embodiment, an abrasive tape from which the loose abrasive grains are removed in advance by re-rolling is used as the abrasive tape 20, which is used during the burnishing process, in the state wound in the roll shape. That is, as described above, when the abrasive tape 20 is formed into the roll shape, the loose abrasive grains are generated due to the pressure from the winding tension, and the loose abrasive grains cause the defective products. In the present embodiment, the roll-type abrasive tape 20 is re-rolled before use, thereby removing the loose abrasive grains. Accordingly, it is possible to reduce the occurrence of defective products of the laminated structure 11A caused by to the loose abrasive grains, and to improve the productivity of the magnetic recording medium 1.

FIG. 4 is a cross sectional view on an enlarged scale illustrating an example of the abrasive tape 20 used for the burnishing. As illustrated in FIG. 4, the abrasive tape 20 can polish the laminated structure 11A by making sliding contact with an abrasive surface (or a polishing surface) S of the laminated structure 11A.

The abrasive tape 20 includes an abrasive material layer 22 provided on a support 21. The abrasive material layer 22 includes abrasive grains 221, and a binder 222 for bonding the abrasive grains 221 to each other and for bonding the abrasive grains 221 to the support 21. The binder 222 also fixes the abrasive grains 221 onto the abrasive material layer 22.

The material used for the support 21 is not particularly limited, and various resins, such as polyethylene terephthalate or the like, for example, can be used for the support 21.

The abrasive grains 221 can be used as an abrasive material included in the abrasive tape 20. The abrasive grains 221 may include grains (or particles) including chromium oxide, α-alumina, silicon carbide, nonmagnetic iron oxide, diamond, γ-alumina, α-γ-alumina, fused alumina, corundum, artificial diamond, or the like, for example. The abrasive grains 221 may be grains (or particles) formed of these materials. Each of these materials may be used by itself, or a combination of two or more of these materials may be used for the abrasive grains 221.

The binder 222 is not particularly limited, and a thermosetting resin, a thermoplastic resin, a photosensitive resin, or the like, for example, can be used for the binder 222. Each of these resins may be used by itself, or a combination of two or more of these resins may be used for the binder 222.

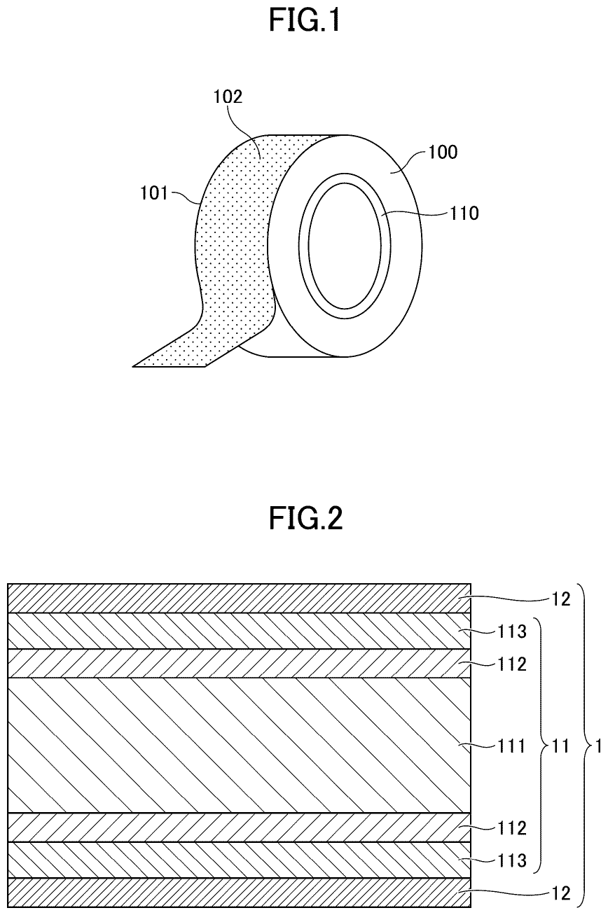

Because the abrasive tape 20 is long as described above, the abrasive tape 20 is supplied in the state wound in the roll shape as illustrated in FIG. 1. The abrasive tape 20 in the state wound in the roll shape is set on a reel of a burnishing apparatus and used.

As described above, when the abrasive tape 20 is wound into the roll shape, the loose abrasive grains are generated inside the roll due to the pressure from the winding tension. In a case where the pressure from the winding tension is very large, the abrasive grains 221 themselves bonded on the support 21 may become loose, but usually, it may be regarded that the abrasive grains 221 weakly bonded onto the support 21 or the abrasive grains 221 adhered onto the bonded abrasive grains 221 become loose. It is difficult to completely remove the loose abrasive grains 221 during the manufacturing process of the abrasive tape 20, and it may be regarded that most of the loose abrasive grains 221 are generated after the abrasive tape 20 is manufactured, that is, after the abrasive tape 20 is wound into the roll shape.

In the present embodiment, the roll-type abrasive tape 20 is re-rolled before use, and the loose abrasive grains 221 are removed by the re-rolling, so that the occurrence of defective products caused by the loose abrasive grains 221 can be reduced. Although the abrasive tape 20 is re-rolled into the roll shape again, because the pressure from the winding tension is already applied to the abrasive tape 20, it is possible to reduce the re-generation of the loose abrasive grains 221 even when the abrasive tape 20 is re-rolled.

A re-rolling speed of the abrasive tape 20 is preferably in a range of approximately 1 m/min to approximately 20 m/min. Because the surface of the abrasive tape 20 receives a wind pressure due to the re-rolling the abrasive tape 20, the loose abrasive grains 221 on the surface of the abrasive tape 20 can be removed by the wind pressure.

Moreover, in the present embodiment, the loose abrasive grains 221 inside the roll-type abrasive tape 20 are preferably removed by blowing off the loose abrasive grains 201 using a gas, as illustrated in FIG. 5. By using such a method, the loose abrasive grains 221 can be removed more efficiently and reliably.

In FIG. 5, the abrasive tape 20 is set on a supply reel 31, and the abrasive tape 20 is wound around a take-up reel 33 while being guided by a guide roller 32. Both surfaces of the abrasive tape 20 are cleaned by the gas discharged from a pair of gas discharge nozzles 34 while running the abrasive tape 20. The removal of the loose abrasive grains 221 is preferably performed in an atmosphere from which static electricity is eliminated, in order to prevent the loose abrasive grains 221 from adhering again due to the static electricity.

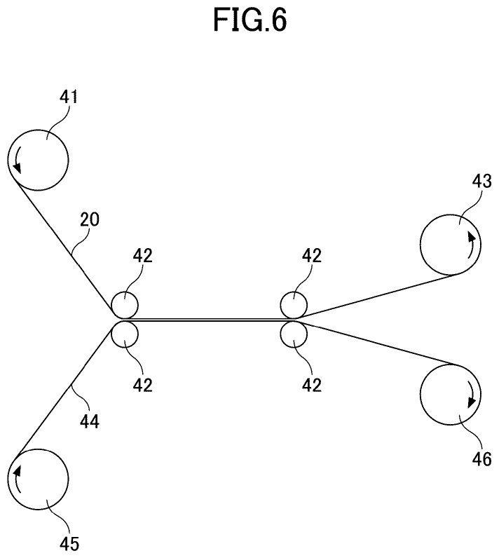

In the present embodiment, as illustrated in FIG. 6, the removal of the loose abrasive grains 221 is preferably performed by bringing another tape 44 into contact with the surface of the abrasive tape 20, thereby causing the loose abrasive grains 221 to be adsorbed onto the other tape 44. By using such a method, the loose abrasive grains 221 can be removed more efficiently and reliably.

In FIG. 6, the abrasive tape 20 is set on an abrasive tape supply reel 41, and the abrasive tape 20 is wound around an abrasive tape take-up reel 43 while being guided by a guide roller 42. The surface of the abrasive tape 20 makes contact with the other tape 44 while the abrasive tape 20 runs, thereby removing the loose abrasive grains 221. A contact surface of the other tape 44, making contact with the surface of the abrasive tape 20, is preferably charged and is adhesive, so that the loose abrasive grains 221 are easily adsorbed onto the other tape 44. The other tape 44 is set on another tape supply reel 45, guided by the guide roller 42 to come into contact with the surface of the abrasive tape 20, and then wound on another tape take-up reel 46.

During the burnishing process, it is possible to employ a method of pressing a tape (the abrasive tape 20) including the abrasive material against the surface of the laminated structure 11A and abrading the surface. The burnishing method and the burnishing apparatus will now be described in detail with reference to the drawings.

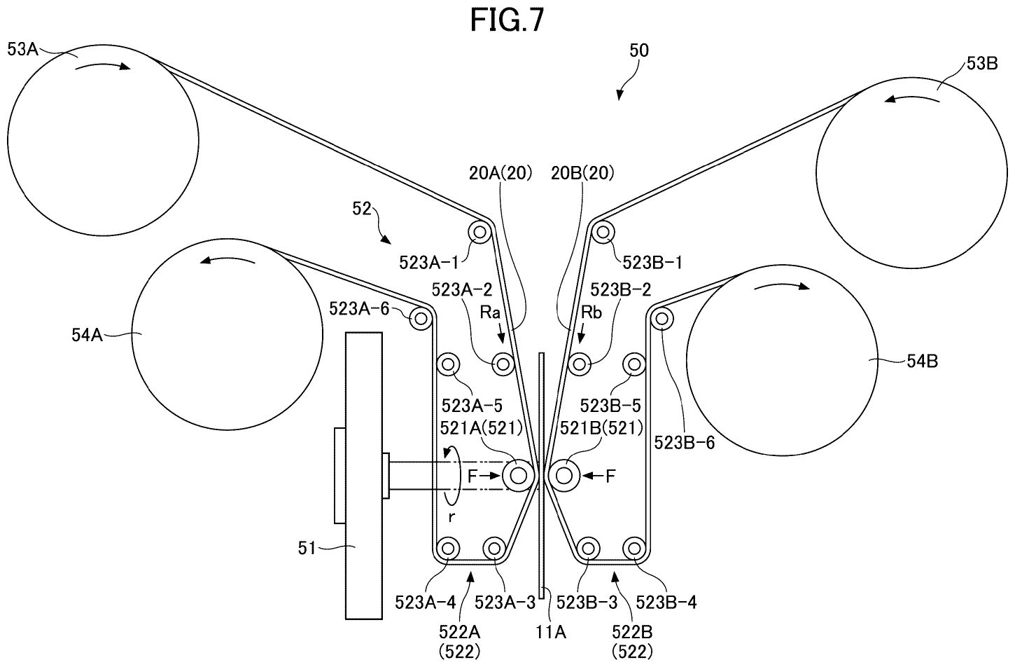

FIG. 7 is a diagram illustrating an example of the burnishing apparatus used in the process of burnishing the surface of the laminated structure 11A with the abrasive tape 20. As illustrated in FIG. 7, a burnishing apparatus 50 includes a pair of abrasive tapes 20 (hereinafter, also referred to as “a pair of abrasive tapes 20A and 20B”) which are disposed to oppose each other so as to pinch both surfaces of the laminated structure 11A from two sides. The burnishing apparatus 50 further includes a rotary support mechanism (or means) 51, and a tape transport mechanism (or means) 52.

The abrasive tapes 20A and 20B are supplied from a first abrasive tape supply reel 53A and a second abrasive tape supply reel 53B, respectively, in a state wound in a roll shape. The supplied abrasive tapes 20A and 20B are wound on a first abrasive tape take-up reel 54A and a second abrasive tape take-up reel 54B, respectively, in a state wound in a roll shape.

In the burnishing apparatus 50, the abrasive tapes 20A and 20B are disposed to oppose each other, so as to pinch the laminated structure 11A from both sides, and thus, it is possible to simultaneously and efficiently perform the burnishing on both surfaces of the laminated structure 11A.

The rotary support mechanism 51 rotates the laminated structure 11A in a circumferential direction (a direction of an arrow r) while supporting a central opening of the laminated structure 11A.

The tape transport mechanism 52 transports the abrasive tapes 20A and 20B relative to each other in a radial direction of the laminated structure 11A, while pressing the abrasive tapes 20A and 20B against both surfaces of the rotating laminated structure 11A in a direction of an arrow F.

In addition, the tape transport mechanism 52 includes a pair of abrasive tape pressing mechanisms 521 and a pair of abrasive tape transport systems 522 which are disposed so as to oppose one another and sandwich the laminated structure 11A from both sides with the pair of abrasive tapes 20A and 20B interposed therebetween.

The pair of abrasive tape pressing mechanisms 521 includes a first abrasive tape pressing mechanism 521A and a second abrasive tape pressing mechanism 521B. The pair of abrasive tape transport systems 522 includes a first abrasive tape transport system 522A and a second abrasive tape transport system 522B.

That is, the tape transport mechanism 52 includes the first abrasive tape transport system 522A and the first abrasive tape pressing mechanism 521A which are disposed on one side of the laminated structure 11A, and the second abrasive tape transport system 522B and the second abrasive tape pressing mechanism 521B which are disposed on the other side of the laminated structure 11A.

The first abrasive tape transport system 522A includes first guide rollers 523A-1 to 523A-6, and causes the abrasive tape 20A to run in a direction of an arrow Ra.

The second abrasive tape transport system 522B includes second guide rollers 523B-1 to 523B-6, and causes the abrasive tape 20B to run in a direction of an arrow Rb.

As described above, the method for manufacturing the magnetic recording medium according to the embodiment includes the burnishing process, and in the burnishing process, the abrasive tape 20 supplied from the state wound in the roll shape is pressed against the surface of the laminated structure 11A, thereby abrading the surface. In this state, the abrasive tape 20 in the state wound in the roll shape is re-rolled in advance to remove the loose abrasive grains. This can prevent the occurrence of circumferential scratches on the surface of the laminated structure 11A due to the loose abrasive grains, and the adhesion of the loose abrasive grains as dirt, such as foreign substances or the like. Hence, according to the method of manufacturing the magnetic recording medium according to the present embodiment, because the rate of occurrence of the defective products of the magnetic recording medium 1 can be reduced during the burnishing process, it is possible to improve the productivity of the magnetic recording medium 1.

As described above, the magnetic recording medium 1 manufactured by the method for manufacturing the magnetic recording medium according to the present embodiment has reduced circumferential scratches and stains on the surface of the magnetic recording medium 1, and thus, it is possible to improve the reliability of a quality of the magnetic recording medium 1. The magnetic recording medium 1 can be suitably used for a magnetic storage apparatus (or magnetic recording and reproducing apparatus) because defects in recording loading and reading can be reduced and a high recording density can be maintained. The form of the magnetic storage apparatus is not particularly limited, as long as the magnetic storage apparatus includes the magnetic recording medium manufactured using the method for manufacturing the magnetic recording medium according to the present embodiment, and the magnetic storage apparatus may be an apparatus that magnetically records information on the magnetic recording medium using a heat-assisted recording method.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

### Exemplary Implementations

Hereinafter, the present embodiment will be described in detail based on exemplary implementations, but the present embodiment is not limited to these exemplary implementations.

### Exemplary Implementation EI1

### [Preparation of Abrasive Tape]

The abrasive tape uses Al₂O₃ having a grain diameter of 0.2 μm (manufactured by Mipox Corporation) as the abrasive grains of the abrasive material. The abrasive tape has a width of 12.6 mm, a length of 100 m, and is wound in a roll shape. The abrasive tape is re-rolled using the apparatus illustrated in FIG. 5 to remove the loose abrasive grains. In this state, the abrasive tape is transported at a transport speed of 10 m/min without discharging the gas from the gas discharge nozzle 34. The re-rolling is performed in an electrostatic discharge safe environment (or a static-free environment).

### [Preparation of Magnetic Recording Medium]

A cleaned glass substrate (having an outer diameter of 2.5 inches and manufactured by HOYA Corporation) is accommodated inside a film deposition chamber of a DC magnetron sputtering apparatus (C-3040 manufactured by Canon Anelva Corporation), and the film deposition chamber is evacuated to an ultimate vacuum of 1×10⁻⁵ Pa. Thereafter, an adhesion layer having a thickness 10 nm is formed on the glass substrate by a sputtering method using a Cr target.

Next, a soft magnetic underlayer is formed on the adhesion layer by sputtering. A first soft magnetic recording layer, an intermediate layer, and a second soft magnetic recording layer are formed in this order, as the soft magnetic underlayer. First, the first soft magnetic recording layer having a thickness of 25 nm is formed on the adhesion layer at a substrate temperature of 100° C. or lower using a Co—20Fe—5Zr—5Ta {a Fe content of 20 at %, a Zr content of 5 at %, a Ta content of 5 at %, and the remainder Co} target. Next, the intermediate layer formed of Ru and having a thickness of 0.7 nm is formed on the first soft magnetic recording layer. Thereafter, the second soft magnetic recording layer formed of Co—20Fe—5Zr—5Ta and having a thickness of 25 nm is formed on the intermediate layer.

Next, a seed layer having a thickness of 5 nm is formed on the soft magnetic underlayer by a sputtering method using a Ni—6W {a W content of 6 at %, and the remainder Ni} target.

Then, a Ru layer having a thickness 10 nm is formed as a first orientation control layer on the seed layer by a sputtering method at a sputtering pressure of 0.8 Pa. Next, a Ru layer having a thickness of 10 nm is formed as a second orientation control layer on the first orientation control layer by a sputtering method at a sputtering pressure of 1.5 Pa.

Next, a first magnetic recording layer formed of 91 (Co15Cr16Pt)—6(SiO₂)—3(TiO₂) {91 mol % of an alloy with a Cr content of 15 at %, a Pt content of 16 at %, and the remainder Co, 6 mol % of SiO₂, and 3 mol % of TiO₂} is formed on the second orientation control layer by a sputtering method to a thickness of 9 nm, at a sputtering pressure of 2 Pa.

Next, a nonmagnetic recording layer formed of 88 (Co30Cr)—12(TiO₂) {88 mol % of an alloy with a Cr content of 30 at % and the remainder Co, and 12 mol % of TiO₂} is formed on the first magnetic recording layer by a sputtering method to a thickness of 0.3 nm.

Thereafter, a second magnetic recording layer formed of 92 (Co11Cr18Pt)—5(SiO₂)—3(TiO₂) {92 mol % of an alloy with a Cr content of 11 at %, a Pt content of 18 at %, and the balance of Co, 5 mol % of SiO₂, and 3 mol % of TiO₂} is formed on the non-magnetic recording layer by a sputtering method to a thickness of 6 nm at a sputtering pressure of 2 Pa.

Next, a non-magnetic recording layer formed of Ru is formed on the second magnetic recording layer by a sputtering method to a thickness of 0.3 nm.

Next, a third magnetic recording layer having a thickness of 7 nm is formed on the non-magnetic recording layer by a sputtering method at a sputtering pressure of 0.6 Pa, using a Co—20Cr—14 Pt—3B {a Cr content of 20 at %, a Pt content of 14 at %, a B content of 3 at %, and the remainder Co} target.

A hydrogenated carbon film is formed as a protective layer on the surface of the third magnetic recording layer by an ion beam deposition method using gasified toluene as a source gas. When forming the hydrogenated carbon film, a flow rate of the source gas supplied to the film deposition chamber is set to 2.9 SCCM, and a reaction pressure is set to 0.2 Pa. Further, a cathode power as an excitation source of the source gas is set to 225 W (AC 22.5 V, 10 A). Then, the hydrogenated carbon film is formed to a thickness of 3.5 nm by setting a voltage between the cathode and an anode covering the cathode to 75 V, a current to 1650 mA, an ion acceleration voltage to 200 V, a current to 180 mA, and a film deposition time to 1.5 seconds. After the hydrogenated carbon film is formed, the supply of the source gas is stopped and the film deposition chamber is evacuated for 2 seconds.

Next, nitrogen gas is supplied into the film deposition chamber by setting a gas flow rate to 2 SCCM and a reaction pressure to 5 Pa. The hydrogenated carbon film is exposed to nitrogen plasma by irradiating the film with nitrogen ions formed from the nitrogen gas by setting the cathode power to 128 W (AC 16 V, 8 A), the voltage between the cathode and anode to 75 V, the current to 1000 mA, the ion acceleration voltage to 200 V, the current to 90 mA, and a processing time to 1 second. Thus, the surface of the hydrogenated carbon film is dehydrogenated and nitrogenated.

Next, a lubricant (D5OH (XS), manufactured by Matsumura Oil Research Corp.) is coated on the surface of the protective layer by the dip coating method, and a lubricant layer formed of the lubricant is formed to a thickness of approximately 7 Å (0.7 nm).

Next, the surface of the laminated structure coated with the lubricant layer is subjected to the burnishing process using the abrasive tape re-rolled by the method described above. The burnishing conditions are such that a rotational speed of the laminated structure is 2000 rpm and the processing time is 7 seconds. By performing the burnishing process, a magnetic recording medium in which the lubricant layer subjected to the burnishing process is laminated on the surface of the laminated structure is obtained.

### Measurement of TA Count

Magnetic recording media manufactured as described above are subjected to an optical inspection, and the magnetic recording media having large scratches or particles adhered thereon are excluded. Next, a burnishing head is used to remove the foreign substances adhered to the magnetic recording medium, and a glide head is used to perform a glide evaluation. The glide evaluation is an evaluation method for detecting vibration that is generated when the glide head hits a protrusion on the surface of the magnetic recording medium, using an acoustic emission (AE) sensor attached to the glide head. A thermal asperity (TA) count is evaluated for the magnetic recording media that passed the glide evaluation. A magneto resistive (MR) head is used for the evaluation of the TA count. The TA count is a method for detecting a phenomenon in which a signal waveform reproduced by the MR head varies due to friction heat that is generated when the MR head hits the protrusion on the surface of the magnetic recording medium, that is, detecting the thermal asperity (TA), and evaluating a surface smoothness of the magnetic recording medium from the number of generated signals (or the TA count). The smaller the TA count, the higher the surface smoothness of the magnetic recording medium. The TA count is determined using the abrasive tape having the length of 100 m, by obtaining an average value of the TA counts per surface of 100 magnetic recording media subjected to the burnishing process using a vicinity of 20 m from one end of the abrasive tape on externally wound side, and an average value of the TA counts per surface of 100 magnetic recording media subjected to the burnishing processing using a vicinity of 80 m from one end of the abrasive tape on the externally wound side. A range in the vicinity of 20 m from one end of the abrasive tape on the externally wound side is positioned outside the roll of the abrasive tape, and the range in the vicinity of 20 m to 100 m in a longitudinal direction of the abrasive tape is positioned inside the roll of the abrasive tape. Evaluation results are illustrated in Table 1.

### Exemplary Implementations EI2 and EI3, and Comparative Example CE1

The magnetic recording media are manufactured in the same manner as in the exemplary implementation EI1, except that the preparation of the abrasive tape is modified as follows, and the TA count is measured. Evaluation results are illustrated in Table 1.

### Exemplary Implementation EI2

The abrasive tape is prepared in the same manner as in the exemplary implementation EI1, except that nitrogen gas is discharged from the gas discharge nozzle 34 of the apparatus illustrated in FIG. 5.

### Exemplary Implementation EI3

The loose abrasive grains are removed by re-rolling the abrasive tape using the apparatus illustrated in FIG. 6. A charged polyethylene tape is used as the other tape to be brought into contact with the abrasive tape. The tape transport speed of the abrasive tape is 10 m/min, and the abrasive tape is discharged and re-rolled. The abrasive tape is prepared in the same manner as in the exemplary implementation EI1, except for the above.

### Comparative Example CE1

The abrasive tape is prepared in the same manner as in the exemplary implementation EI1, except that the re-rolling of the abrasive tape is not performed.

TABLE 1

| | TA COUNT | |
|---|---|---|
| | VICINITY OF 20 m FROM | VICINITY OF 80 m FROM |
| | ONE END OF ABRASIVE | ONE END OF ABRASIVE |
| | TAPE ON EXTERNALLY | TAPE ON EXTERNALLY |
| | WOUND SIDE | WOUND SIDE |
| EI1 | 9 | 9 |
| EI2 | 8 | 8 |
| EI3 | 8 | 8 |
| CE1 | 50 | 10 |

As illustrated in Table 1, in the comparative example CE1, the TA count is different between the inside and the outside of the roll of the abrasive tape subjected to the burnishing processed. It may be regarded that this difference is due to the pressure from the winding tension of the roll-type abrasive tape that causes a difference in the amount of loose abrasive grains to occur between the inner side and the outer side of the roll of the abrasive tape. On the other hand, in the exemplary implementations EI1 to EI3, the TA count is the same between the inside and the outside of the roll of the abrasive tape. It may be regarded that the TA count is the same because the loose abrasive grains inside and outside the roll of the abrasive tape are removed by re-rolling the roll of the abrasive tape.

Accordingly, it may be regarded that the rate of occurrence of defective products during the burnishing process of the magnetic recording medium to be manufactured can be reduced, and the productivity of the magnetic recording medium can be improved, by re-rolling the roll of the abrasive tape when preparing the abrasive tape.

Accordingly to one aspect of the embodiments, it is possible to provide a method for manufacturing a magnetic recording medium, capable of improving the productivity of the magnetic recording media.

Although the exemplary implementations are numbered with, for example, “EI1,” “EI2,” or “EI3,” the ordinal numbers do not imply priorities of the exemplary implementations. Many other variations and modifications will be apparent to those skilled in the art.

What is claimed is:

1. A method for manufacturing a magnetic recording medium, comprising:
burnishing a surface of a laminated structure using an abrasive material, the laminated structure including a magnetic recording layer and a protective layer successively laminated on a substrate, wherein:
the burnishing includes using a long abrasive tape including abrasive grains as the abrasive material fixed on a support in a state wound in a roll shape, and
pressing the abrasive tape supplied from the state wound in the roll shape against the surface of the laminated structure, thereby abrading the surface of the laminated structure, and
the abrasive tape in the state wound in the roll shape is re-rolled in advance to remove loose abrasive grains therefrom.

2. The method for manufacturing the magnetic recording medium as claimed in claim 1, wherein the loose abrasive grains are abrasive grains released from the support of the abrasive tape.

3. The method for manufacturing the magnetic recording medium as claimed in claim 1, wherein the loose abrasive grains are removed by blowing off the loose abrasive grains using a gas.

4. The method for manufacturing the magnetic recording medium as claimed in claim 1, wherein the loose abrasive grains are removed by bringing another tape into contact with the surface of the abrasive tape to adsorb the loose abrasive grains onto the other tape.

5. The method of manufacturing the magnetic recording medium as claimed in claim 1, further comprising:
forming a lubricant layer on the surface of the laminated structure,
wherein the burnishing burnishes the surface of the laminated structure formed with the lubricant layer using the abrasive material.
